(19) United States
(12) Patent Application Publication
(10) Pub. No.: US 2026/0330224 A1
(43) Pub. Date: Oct. 22, 2026

(54) System, Method, and Computer Program Product for Analyzing And/or Improving Transformer Models

(71) Applicant: Visa International Service Association, San Francisco, CA (US)

(72) Inventors: Yiran Li, Davis, CA (US); Junpeng Wang, Santa Clara, CA (US); Xin Dai, Fremont, CA (US); Liang Wang, San Jose, CA (US); Michael Yeh, Newark, CA (US); Yan Zheng, Los Gatos, CA (US); Wei Zhang, Fremont, CA (US)

(21) Appl. No.: 19/120,375

(22) PCT Filed: Oct. 13, 2023
(86) PCT No.: PCT/US23/35109

§ 371 Date: Apr. 11, 2025

Related U.S. Application Data
(60) Provisional application No. 63/415,777, filed on Oct. 13, 2022.

(51) Int. Cl. G06N 3/082; G06N 3/0455

(52) U.S. Cl. CPC G06N 3/082; G06N 3/0455

(57) ABSTRACT

Methods, systems, and computer program products are provided for analyzing and/or improving transformer models. A method may include receiving a trained transformer model. The trained transformer model may include at least one multi-head self-attention layer including a plurality of attention heads. At least one sample may be received. The sample(s) may be inputted to the trained transformer model to generate at least one layer output of the multi-head self-attention layer(s) and at least one model output of the trained transformer model. Each respective attention head may be pruned, and the sample(s) may be inputted to the trained transformer model with the respective attention head pruned to generate at least one respective pruned layer output and at least one respective pruned model output. At least one importance metric may be determined for each respective attention head based on at least two of the aforementioned outputs.

### CROSS REFERENCE TO RELATED APPLICATIONS

This application is the United States national phase of International Application No. PCT/US23/35109 filed Oct. 13, 2023, and claims priority to U.S. Provisional Patent Application No. 63/415,777, filed Oct. 13, 2022, the disclosures of which are hereby incorporated by reference in their entireties.

### BACKGROUND

### 1. Technical Field

This disclosure relates generally to analyzing and/or improving transformer models and, in some non-limiting embodiments or aspects, to systems, methods, and computer program products for analyzing and/or improving a vision transformer model.

### 2. Technical Considerations

Certain machine learning models, such as transformer models, vision transformer (ViT) models, and/or the like, may include multi-head self-attention layers. For example, a ViT model may decompose an image into many smaller patches, arrange the patches into a sequence, and apply the multi-head self-attention layers to the sequence of patches to learn the attention between patches.

However, it can be difficult to interpret the behavior of such machine learning models. For example, a transformer model, such as a ViT model, may include multiple self-attention layers that each have multiple attention heads, and it may be difficult to determine the importance and/or functionality of each attention head. For example, each individual attention head may have a different impact on the output of a self-attention layer and/or a different impact on the overall output of the model. Additionally, it may be difficult to determine the attention strength between individual patches and neighboring patches (e.g., in multiple directions, multiple hops away, etc.) for different attention heads. These difficulties in interpretation of the individual attention heads may be exacerbated in a ViT model, since the patches of an image have a two-dimensional relationship (e.g., a two-dimensional grid of patches, as opposed to a sequence of words, in which the relationship between words is one-dimensional (e.g., linear)). In addition, it may be difficult to determine the different attention patterns that different attention heads have learned. The aforementioned difficulties in interpreting the model may, therefore, result in difficulties understanding the model's behavior, diagnosing problems with the model's performance, and/or making strategic decisions with respect to deploying the model.

### SUMMARY

Accordingly, provided are improved systems, methods, and computer program products for analyzing and/or improving transformer models.

According to non-limiting embodiments or aspects, provided is a computer-implemented method for analyzing and/or improving transformer models. The method may include receiving a trained transformer model. The trained transformer model may include at least one multi-head self-attention layer, which may include a plurality of attention heads. At least one sample may be received. The at least one sample may be inputted to the trained transformer model to generate at least one layer output of the at least one multi-head self-attention layer and at least one model output of the trained transformer model. For each respective attention head of the plurality of attention heads, the respective attention head may be pruned and the at least one sample may be inputted to the trained transformer model with the respective attention head pruned to generate at least one respective pruned layer output of the at least one multi-head self-attention layer and at least one respective pruned model output of the trained transformer model. At least one importance metric may be determined for each respective attention head of the plurality of attention heads based on at least two of: the at least one layer output, the at least one model output, the at least one respective pruned layer output for the respective attention head, the at least one respective pruned model output for the respective attention head, or any combination thereof.

In some non-limiting embodiments or aspects, the trained transformer model may include a trained vison transformer (ViT) model. Additionally or alternatively, the at least one sample may include at least one image.

In some non-limiting embodiments or aspects, the at least one sample may include a natural language sample.

In some non-limiting embodiments or aspects, the at least one sample may include at least one time series data item.

In some non-limiting embodiments or aspects, pruning the respective attention head may include setting at least a portion of a respective attention matrix of the respective attention head to 0.

In some non-limiting embodiments or aspects, determining the at least one importance metric may include determining at least one of: a probability change importance metric based on the at least one model output and the at least one respective pruned model output for the respective attention head, a Jensen-Shannon Divergence (JSD) importance metric based on the at least one model output and the at least one respective pruned model output for the respective attention head, a layer importance metric based on the at least one layer output and the at least one respective pruned layer output for the respective attention head, or any combination thereof. For example, the layer importance metric may include at least one of: a class token-based layer importance metric, a patch token-based layer importance metric, or any combination thereof.

In some non-limiting embodiments or aspects, for each respective attention head of the plurality of attention heads, a respective attention strength vector may be generated for the respective attention head based on an attention strength between each patch of the at least one sample and each other patch of the at least one sample.

In some non-limiting embodiments or aspects, each respective attention head of the plurality of attention heads may be associated with a respective attention matrix. For example, a plurality of attention matrices may include the respective attention matrix for each respective attention head of the plurality of attention heads. In some non-limiting embodiments or aspects, a respective embedding may be generated for each respective attention matrix of the plurality of attention matrices. For example, a plurality of embeddings comprises each respective embedding for each respective attention matrix of the plurality of attention matrices. The plurality of embeddings may be clustered to provide at least one cluster. At least one attention pattern may be determined based on the at least one cluster.

In some non-limiting embodiments or aspects, generating the respective embedding for each respective attention matrix of the plurality of attention matrices may include training an autoencoder based on the plurality of attention matrices to provide a trained autoencoder. A respective latent representation may be generated for each respective attention matrix of the plurality of attention matrices based on the trained autoencoder. In some non-limiting embodiments or aspects, the respective latent representation for each respective attention matrix may include the respective embedding for each respective attention matrix. In some non-limiting embodiments or aspects, generating the respective embedding for each respective attention matrix of the plurality of attention matrices may further include generating the respective embedding for each respective attention matrix of the plurality of attention matrices based on applying t-distributed stochastic neighbor embedding (tSNE) for each latent representation of each respective attention matrix of the plurality of attention matrices.

In some non-limiting embodiments or aspects, a graphical user interface include at least one view may be generated. For example, the at least one view may include at least one of: a head importance view, a head attention strength view, a head attention pattern view, an image overview view, or any combination thereof.

According to non-limiting embodiments or aspects, provided is a system for analyzing and/or improving transformer models. The system may include at least one processor and at least one non-transitory computer-readable medium storing instructions that, when executed by the at least one processor, cause the at least one processor to perform any of the methods described herein.

According to non-limiting embodiments or aspects, provided is a computer program product for analyzing and/or improving transformer models. The computer program product may include at least one non-transitory computer-readable medium including program instructions that, when executed by at least one processor, cause the at least one processor to perform any of the methods described herein.

According to non-limiting embodiments or aspects, provided is a system for analyzing and/or improving transformer models. The system may include at least one processor and at least one non-transitory computer-readable medium storing instructions that, when executed by the at least one processor, cause the at least one processor to receive a trained transformer model. The trained transformer model comprising at least one multi-head self-attention layer comprising a plurality of attention heads. The instructions, when executed by the at least one processor, may cause the at least one processor to receive at least one sample. The instructions, when executed by the at least one processor, may cause the at least one processor to input the at least one sample to the trained transformer model to generate at least one layer output of the at least one multi-head self-attention layer and at least one model output of the trained transformer model. For each respective attention head of the plurality of attention heads, the instructions, when executed by the at least one processor, may cause the at least one processor to prune the respective attention head and input the at least one sample to the trained transformer model with the respective attention head pruned to generate at least one respective pruned layer output of the at least one multi-head self-attention layer and at least one respective pruned model output of the trained transformer model. The instructions, when executed by the at least one processor, may cause the at least one processor to determine at least one importance metric for each respective attention head of the plurality of attention heads based on at least two of: the at least one layer output, the at least one model output, the at least one respective pruned layer output for the respective attention head, the at least one respective pruned model output for the respective attention head, or any combination thereof.

In some non-limiting embodiments or aspects, pruning the respective attention head may include setting at least a portion of a respective attention matrix of the respective attention head to 0.

In some non-limiting embodiments or aspects, the instructions, when executed by the at least one processor, may further cause the at least one processor to generate, for each respective attention head of the plurality of attention heads, a respective attention strength vector for the respective attention head based on an attention strength between each patch of the at least one sample and each other patch of the at least one sample.

In some non-limiting embodiments or aspects, each respective attention head of the plurality of attention heads may be associated with a respective attention matrix. A plurality of attention matrices may include the respective attention matrix for each respective attention head of the plurality of attention heads. The instructions, when executed by the at least one processor, may further cause the at least one processor to generate a respective embedding for each respective attention matrix of the plurality of attention matrices, and a plurality of embeddings may include each respective embedding for each respective attention matrix of the plurality of attention matrices. The instructions, when executed by the at least one processor, may further cause the at least one processor to cluster the plurality of embeddings to provide at least one cluster. The instructions, when executed by the at least one processor, may further cause the at least one processor to determine at least one attention pattern based on the at least one cluster.

In some non-limiting embodiments or aspects, generating the respective embedding for each respective attention matrix of the plurality of attention matrices may include training an autoencoder based on the plurality of attention matrices to provide a trained autoencoder and/or generating a respective latent representation for each respective attention matrix of the plurality of attention matrices based on the trained autoencoder.

In some non-limiting embodiments or aspects, generating the respective embedding for each respective attention matrix of the plurality of attention matrices may further include generating the respective embedding for each respective attention matrix of the plurality of attention matrices based on applying t-distributed stochastic neighbor embedding (tSNE) for each latent representation of each respective attention matrix of the plurality of attention matrices.

According to non-limiting embodiments or aspects, provided is a computer program product for analyzing and/or improving transformer models. The computer program product may include at least one non-transitory computer-readable medium including program instructions that, when executed by at least one processor, cause the at least one processor to receive a trained transformer model. The trained transformer model comprising at least one multi-head self-attention layer comprising a plurality of attention heads. The instructions, when executed by the at least one processor, may cause the at least one processor to receive at least one sample. The instructions, when executed by the at least one processor, may cause the at least one processor to input the at least one sample to the trained transformer model to generate at least one layer output of the at least one multi-head self-attention layer and at least one model output of the trained transformer model. For each respective attention head of the plurality of attention heads, the instructions, when executed by the at least one processor, may cause the at least one processor to prune the respective attention head and input the at least one sample to the trained transformer model with the respective attention head pruned to generate at least one respective pruned layer output of the at least one multi-head self-attention layer and at least one respective pruned model output of the trained transformer model. The instructions, when executed by the at least one processor, may cause the at least one processor to determine at least one importance metric for each respective attention head of the plurality of attention heads based on at least two of: the at least one layer output, the at least one model output, the at least one respective pruned layer output for the respective attention head, the at least one respective pruned model output for the respective attention head, or any combination thereof.

Further non-limiting embodiments or aspects are set forth in the following numbered clauses:

Clause 1: A computer-implemented method, comprising: receiving, with at least one processor, a trained transformer model, the trained transformer model comprising at least one multi-head self-attention layer comprising a plurality of attention heads; receiving, with at least one processor, at least one sample; inputting, with at least one processor, the at least one sample to the trained transformer model to generate at least one layer output of the at least one multi-head self-attention layer and at least one model output of the trained transformer model; for each respective attention head of the plurality of attention heads, pruning, with at least one processor, the respective attention head and inputting the at least one sample to the trained transformer model with the respective attention head pruned to generate at least one respective pruned layer output of the at least one multi-head self-attention layer and at least one respective pruned model output of the trained transformer model; and determining, with at least one processor, at least one importance metric for each respective attention head of the plurality of attention heads based on at least two of: the at least one layer output, the at least one model output, the at least one respective pruned layer output for the respective attention head, the at least one respective pruned model output for the respective attention head, or any combination thereof.

Clause 2: The method of clause 1, wherein the trained transformer model comprises a trained vison transformer (ViT) model and the at least one sample comprises at least one image.

Clause 3: The method of clauses 1 or 2, wherein the at least one sample comprises a natural language sample.

Clause 4: The method of any of clauses 1-3, wherein the at least one sample comprises at least one time series data item.

Clause 5: The method of any of clauses 1-4, wherein pruning the respective attention head comprises setting at least a portion of a respective attention matrix of the respective attention head to 0.

Clause 6: The method of any of clauses 1-5, wherein determining the at least one importance metric comprises determining at least one of: a probability change importance metric based on the at least one model output and the at least one respective pruned model output for the respective attention head; a Jensen-Shannon Divergence (JSD) importance metric based on the at least one model output and the at least one respective pruned model output for the respective attention head; a layer importance metric based on the at least one layer output and the at least one respective pruned layer output for the respective attention head; or any combination thereof.

Clause 7: The method of any of clauses 1-6, wherein the layer importance metric comprises at least one of: a class token-based layer importance metric, a patch token-based layer importance metric, or any combination thereof.

Clause 8: The method of any of clauses 1-7, further comprising: for each respective attention head of the plurality of attention heads, generating, with at least one processor, a respective attention strength vector for the respective attention head based on an attention strength between each patch of the at least one sample and each other patch of the at least one sample.

Clause 9: The method of any of clauses 1-8, wherein each respective attention head of the plurality of attention heads is associated with a respective attention matrix, wherein a plurality of attention matrices comprises the respective attention matrix for each respective attention head of the plurality of attention heads, the method further comprising: generating, with at least one processor, a respective embedding for each respective attention matrix of the plurality of attention matrices, wherein a plurality of embeddings comprises each respective embedding for each respective attention matrix of the plurality of attention matrices; clustering, with at least one processor, the plurality of embeddings to provide at least one cluster; and determining, with at least one processor, at least one attention pattern based on the at least one cluster.

Clause 10: The method of any of clauses 1-9, wherein generating the respective embedding for each respective attention matrix of the plurality of attention matrices comprises: training, with at least one processor, an autoencoder based on the plurality of attention matrices to provide a trained autoencoder; and generating, with at least one processor, a respective latent representation for each respective attention matrix of the plurality of attention matrices based on the trained autoencoder.

Clause 11: The method of any of clauses 1-10, wherein the respective latent representation for each respective attention matrix comprises the respective embedding for each respective attention matrix.

Clause 12: The method of any of clauses 1-11, wherein generating the respective embedding for each respective attention matrix of the plurality of attention matrices further comprises: generating, with at least one processor, the respective embedding for each respective attention matrix of the plurality of attention matrices based on applying t-distributed stochastic neighbor embedding (tSNE) for each latent representation of each respective attention matrix of the plurality of attention matrices.

Clause 13: The method of any of clauses 1-12, further comprising: generating, with at least one processor, a graphical user interface comprising at least one view.

Clause 14: The method of any of clauses 1-13, wherein the at least one view comprises at least one of: a head importance view; a head attention strength view; a head attention pattern view; an image overview view; or any combination thereof.

Clause 15: A system comprising: at least one processor; and at least one non-transitory computer-readable medium storing instructions that, when executed by the at least one processor, cause the at least one processor to: receive a trained transformer model, the trained transformer model comprising at least one multi-head self-attention layer comprising a plurality of attention heads; receive at least one sample; input the at least one sample to the trained transformer model to generate at least one layer output of the at least one multi-head self-attention layer and at least one model output of the trained transformer model; for each respective attention head of the plurality of attention heads, prune the respective attention head and input the at least one sample to the trained transformer model with the respective attention head pruned to generate at least one respective pruned layer output of the at least one multi-head self-attention layer and at least one respective pruned model output of the trained transformer model; and determine at least one importance metric for each respective attention head of the plurality of attention heads based on at least two of: the at least one layer output, the at least one model output, the at least one respective pruned layer output for the respective attention head, the at least one respective pruned model output for the respective attention head, or any combination thereof.

Clause 16: The system of clause 15, wherein pruning the respective attention head comprises setting at least a portion of a respective attention matrix of the respective attention head to 0.

Clause 17: The system of clause 15 or clause 16, wherein the instructions, when executed by the at least one processor, further cause the at least one processor to: for each respective attention head of the plurality of attention heads, generate a respective attention strength vector for the respective attention head based on an attention strength between each patch of the at least one sample and each other patch of the at least one sample.

Clause 18: The system of any of clauses 15-17, wherein each respective attention head of the plurality of attention heads is associated with a respective attention matrix, wherein a plurality of attention matrices comprises the respective attention matrix for each respective attention head of the plurality of attention heads, wherein the instructions, when executed by the at least one processor, further cause the at least one processor to: generate a respective embedding for each respective attention matrix of the plurality of attention matrices, wherein a plurality of embeddings comprises each respective embedding for each respective attention matrix of the plurality of attention matrices; cluster the plurality of embeddings to provide at least one cluster; and determine at least one attention pattern based on the at least one cluster, wherein generating the respective embedding for each respective attention matrix of the plurality of attention matrices comprises: training an autoencoder based on the plurality of attention matrices to provide a trained autoencoder; and generating a respective latent representation for each respective attention matrix of the plurality of attention matrices based on the trained autoencoder.

Clause 19: The system of any of clauses 15-18, wherein generating the respective embedding for each respective attention matrix of the plurality of attention matrices further comprises: generating the respective embedding for each respective attention matrix of the plurality of attention matrices based on applying t-distributed stochastic neighbor embedding (tSNE) for each latent representation of each respective attention matrix of the plurality of attention matrices.

Clause 20: A computer program product comprising at least one non-transitory computer-readable medium including program instructions that, when executed by at least one processor, cause the at least one processor to: receive a trained transformer model, the trained transformer model comprising at least one multi-head self-attention layer comprising a plurality of attention heads; receive at least one sample; input the at least one sample to the trained transformer model to generate at least one layer output of the at least one multi-head self-attention layer and at least one model output of the trained transformer model; for each respective attention head of the plurality of attention heads, prune the respective attention head and input the at least one sample to the trained transformer model with the respective attention head pruned to generate at least one respective pruned layer output of the at least one multi-head self-attention layer and at least one respective pruned model output of the trained transformer model; and determine at least one importance metric for each respective attention head of the plurality of attention heads based on at least two of: the at least one layer output, the at least one model output, the at least one respective pruned layer output for the respective attention head, the at least one respective pruned model output for the respective attention head, or any combination thereof.

Clause 21: A system comprising: at least one processor; and at least one non-transitory computer-readable medium storing instructions that, when executed by the at least one processor, cause the at least one processor to perform the method of any of clauses 1-14.

Clause 22: A computer program product comprising at least one non-transitory computer-readable medium including program instructions that, when executed by at least one processor, cause the at least one processor to perform the method of any of clauses 1-14.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for analyzing and/or improving transformer models, according to some non-limiting embodiments or aspects;

FIG. 2 is a flow diagram for a method for analyzing and/or improving transformer models, according to some non-limiting embodiments or aspects;

FIG. 3 is a diagram of an exemplary environment in which methods, systems, and/or computer program products, described herein, may be implemented, according to some non-limiting embodiments or aspects;

FIG. 4 is a schematic diagram of example components of one or more devices of FIG. 1 and/or FIG. 3, according to some non-limiting embodiments or aspects;

FIG. 5 is a schematic diagram of a vision transformer model, according to some non-limiting embodiments or aspects;

FIGS. 6A-6D are screenshots of a graphical user interface, according to some non-limiting embodiments or aspects;

FIGS. 7A-7F are diagrams of different pruning modes, according to some non-limiting embodiments or aspects;

FIGS. 8A and 8B are diagrams showing generation of attention strength vectors, according to some non-limiting embodiments or aspects;

FIG. 9 is a schematic diagram of attentions, according to some non-limiting embodiments or aspects; and

FIG. 10 is a diagram of attention patterns, according to some non-limiting embodiments or aspects.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer (e.g., laptop computer, a tablet computer, and/or the like), a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to systems, methods, and computer program products for analyzing and/or improving transformer models, including, but not limited to, a vision transformer model. For example, non-limiting embodiments or aspects of the disclosed subject matter provide receiving a trained transformer model including at least one multi-head self-attention layer comprising a plurality of attention heads and receiving at least one sample. The sample(s) may be inputted to the trained transformer model to generate at least one layer output of the multi-head self-attention layer(s) and at least one model output of the trained transformer model. For each respective attention head, the respective attention head may be pruned and the sample may be inputted to the trained transformer model (e.g., with the respective attention head pruned) to generate at least one respective pruned layer output of the multi-head self-attention layer(s) and at least one respective pruned model output of the trained transformer model. At least one importance metric may be determined for each respective attention head of the plurality of attention heads based on at least two of: the layer output(s), the model output(s), the respective pruned layer output(s) for the respective attention head, the respective pruned model output(s) for the respective attention head, or any combination thereof. Such embodiments or aspects provide methods and systems that enable determination of the importance and/or functionality of each attention head. For example, the importance metric(s) may quantify the importance of each attention head, such as overall importance (e.g., impact on the overall output of the model) and/or local (e.g., immediate, layer-based, and/or the like) importance (e.g., impact on the output of a self-attention layer). Additionally, non-limiting embodiments or aspects of the disclosed subject matter provide, for each respective attention head of the plurality of attention heads, generating a respective attention strength vector for the respective attention head based on an attention strength between each patch of the at least one sample and each other patch of the at least one sample. Such embodiments or aspects provide methods and systems that enable determination of the attention strength between individual patches and neighboring patches (e.g., in multiple directions, multiple hops away, etc.) for different attention heads. In addition, non-limiting embodiments or aspects of the disclosed subject matter provide that each respective attention head is associated with a respective attention matrix (e.g., collectively forming a plurality of attention matrices) and provide generating a respective embedding for each respective attention matrix (e.g., collectively forming a plurality of embeddings), clustering the plurality of embeddings to provide at least one cluster, and determining at least one attention pattern based on the cluster(s). Such embodiments or aspects provide methods and systems that enable determination of the different attention patterns that different attention heads have learned. In addition, non-limiting embodiments or aspects of the disclosed subject matter provide generating a graphical user interface comprising at least one view (e.g., a head importance view, a head attention strength view, a head attention pattern view, an image overview view, or any combination thereof). Such embodiments or aspects provide methods and systems that provide an interactive, visual presentation that enables interpretation of transformer models (e.g., ViT models), e.g., by summarizing voluminous information about such models in compact views that can be displayed on a single screen and/or that interactively provide additional information upon interaction with the graphical user interface. As such, the disclosed subject matter enables interpretation of the machine learning model (e.g., transformer model, ViT model, and/or the like) and, therefore, allows for understanding the model's behavior, diagnosing problems with the model's performance (e.g., determining which attention head(s) contributed to an incorrect prediction), and/or making strategic decisions with respect to deploying the model (e.g., compressing the model by pruning and/or eliminating attention heads that are unimportant (e.g., less important, low importance metric(s), and/or the like), redundant (e.g., one of multiple attention heads that learned the same pattern), and/or the like).

For the purpose of illustration, in the following description, while the presently disclosed subject matter is described with respect to systems, methods, and computer program products for analyzing and/or improving machine learning models, e.g., vision transformer models, one skilled in the art will recognize that the disclosed subject matter is not limited to the illustrative embodiments. For example, the systems, methods, and computer program products described herein may be used with a wide variety of settings, such as analyzing and/or improving any suitable type of machine learning model, e.g., a transformer model, a multi-head self-attention model, an attention model, and/or the like.

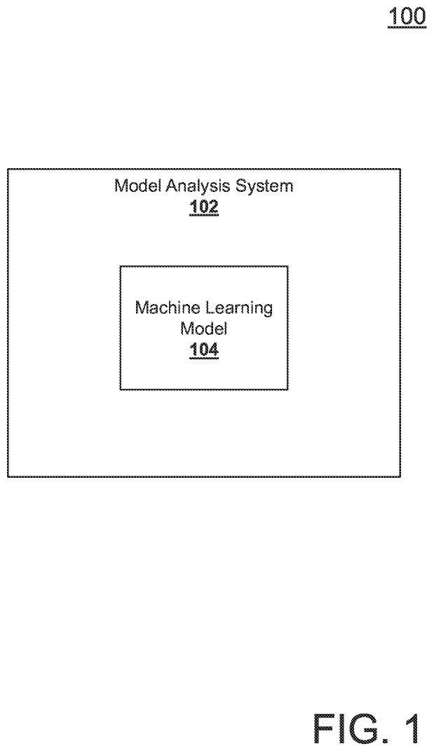

FIG. 1 depicts a system 100 for analyzing and/or improving transformer models according to some non-limiting embodiments or aspects. The system 100 may include model analysis system 102 and machine learning model 104.

Model analysis system 102 may include at least one computing device, such as a server (e.g., a single server), a group of servers, a computer (e.g., portable computer, non-mobile computer, and/or the like), and/or other like devices. In some non-limiting embodiments or aspects, model analysis system 102 may include at least one processor (e.g., a multi-core processor) such as a graphics processing unit (GPU), a central processing unit (CPU), an accelerated processing unit (APU), a microprocessor, and/or the like. In some non-limiting embodiments or aspects, model analysis system 102 may include memory, one or more storage components, one or more input components, one or more output components, and/or one or more communication interfaces, as described herein.

Machine learning model 104 may include at least one machine learning model. For example, machine learning model 104 may include at least one attention model, at least one self-attention model, at least one multi-head self-attention model, at least one transformer model, at least one vision transformer (ViT) model, at least one convolutional neural network (CNN), at least one neural network, at least one multilayer perceptron (MLP), at least one deep neural network (DNN), and/or the like. In some non-limiting embodiments or aspects, machine learning model 104 may be trained (e.g., by model analysis system 102 and/or a separate system) based on a plurality of sample(s) (e.g., image samples and/or the like), as described herein. In some non-limiting embodiments or aspects, machine learning model 104 may be used (e.g., by model analysis system 102 and/or a separate system) to generate (e.g., during and/or after training) a prediction (e.g., image classification and/or the like) as described herein. In some non-limiting embodiments or aspects, machine learning model 104 may be implemented by (e.g., stored in, executed by, and/or the like) model analysis system 102. In some non-limiting embodiments or aspects, machine learning model 104 may be implemented by (e.g., stored in, executed by, and/or the like) another system, another device, another group of systems, and/or another group of devices, separate from or including model analysis system 102. For example, the other system, other device, other group of systems, and/or other group of devices may be in communication with model analysis system 102, as described herein.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

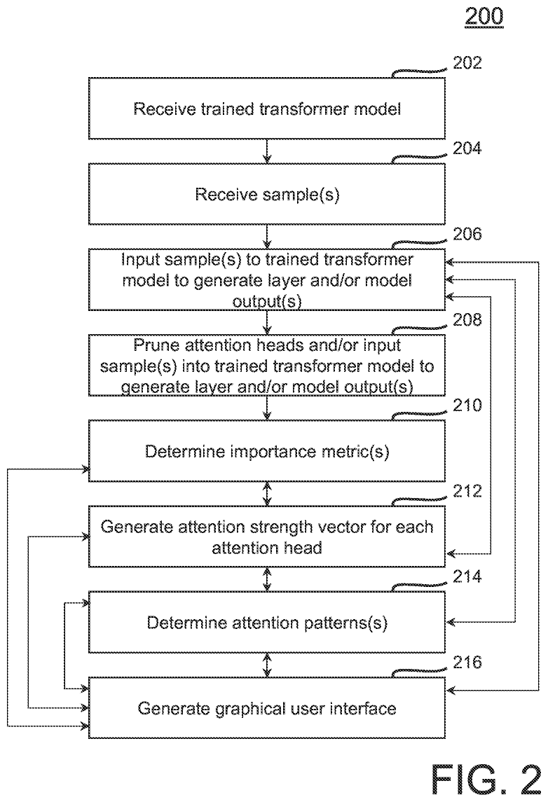

Referring now to FIG. 2, shown is a process 200 for analyzing and/or improving transformer models, according to some non-limiting embodiments or aspects. The steps shown in FIG. 2 are for example purposes only. It will be appreciated that additional, fewer, different, and/or a different order of steps may be used in non-limiting embodiments or aspects. In some non-limiting embodiments or aspects, one or more of the steps of process 200 may be performed (e.g., completely, partially, and/or the like) by model analysis system 102 (e.g., one or more devices of model analysis system 102). In some non-limiting embodiments or aspects, one or more of the steps of process 200 may be performed (e.g., completely, partially, and/or the like) by another system, another device, another group of systems, or another group of devices, separate from or including model analysis system 102.

As shown in FIG. 2, at step 202, process 200 may include receiving a trained transformer model. For example, model analysis system 102 may receive a trained transformer model. The trained transformer model may include at least one multi-head self-attention layer, and each multi-head self-attention layer may include a plurality of attention heads.

In some non-limiting embodiments or aspects, the trained transformer model may include a trained vison transformer (ViT) model. Additionally or alternatively, the at least one sample may include at least one image.

In some non-limiting embodiments or aspects, the at least one sample may include a natural language sample.

In some non-limiting embodiments or aspects, the at least one sample may include at least one time series data item.

As shown in FIG. 2, at step 204, process 200 may include receiving at least one sample. For example, model analysis system 102 may receive at least one sample.

As shown in FIG. 2, at step 206, process 200 may include inputting the sample(s) to the trained transformer model to generate at least one layer and/or model output. For example, model analysis system 102 may input the sample(s) to the trained transformer model to generate at least one layer output of the multi-head self-attention layer(s) and at least one model output of the trained transformer model.

As shown in FIG. 2, at step 208, process 200 may include pruning attention heads and/or inputting sample(s) into the trained transformer model (e.g., with attention heads pruned) to generate layer and/or model output(s) (e.g., pruned layer output(s) and/or pruned model output(s)). For example, for each respective attention head of the plurality of attention heads, model analysis system 102 may prune the respective attention head and input the sample(s) to the trained transformer model with the respective attention head pruned to generate at least one respective pruned layer output of the multi-head self-attention layer(s) and at least one respective pruned model output of the trained transformer model.

In some non-limiting embodiments or aspects, pruning the respective attention head may include setting at least a portion of a respective attention matrix of the respective attention head to 0.

As shown in FIG. 2, at step 210, process 200 may include determining importance metrics. For example, model analysis system 102 may determine at least one importance metric for each respective attention head of the plurality of attention heads based on at least two of: the layer output(s), the model output(s), the respective pruned layer output(s) for the respective attention head, the at least one respective pruned model output for the respective attention head, or any combination thereof.

In some non-limiting embodiments or aspects, determining the at least one importance metric may include determining at least one of: a probability change importance metric based on the at least one model output and the at least one respective pruned model output for the respective attention head, a Jensen-Shannon Divergence (JSD) importance metric based on the at least one model output and the at least one respective pruned model output for the respective attention head, a layer importance metric based on the at least one layer output and the at least one respective pruned layer output for the respective attention head, or any combination thereof. For example, the layer importance metric may include at least one of a class token-based layer importance metric, a patch token-based layer importance metric, or any combination thereof.

As shown in FIG. 2, at step 212, process 200 may include generating an attention strength vector for each attention head. For example, for each respective attention head of the plurality of attention heads, model analysis system 102 may generate a respective attention strength vector for the respective attention head based on an attention strength between each patch of the at least one sample and each other patch of the at least one sample.

As shown in FIG. 2, at step 214, process 200 may include determining at least one attention pattern. For example, model analysis system 102 may determine the attention pattern(s).

In some non-limiting embodiments or aspects, each respective attention head of the plurality of attention heads may be associated with a respective attention matrix (e.g., a plurality of attention matrices may include the respective attention matrix for each respective attention head of the plurality of attention heads). In some non-limiting embodiments or aspects, determining the attention patterns may include generating (e.g., by model analysis system 102) a respective embedding for each respective attention matrix of the plurality of attention matrices (e.g. a plurality of embeddings may include each respective embedding for each respective attention matrix of the plurality of attention matrices). The plurality of embeddings may be clustered (e.g., by model analysis system 102) to provide at least one cluster. Model analysis system 102 may determine at least one attention pattern based on the cluster(s).

In some non-limiting embodiments or aspects, generating the respective embedding for each respective attention matrix of the plurality of attention matrices may include training (e.g., by model analysis system 102) an autoencoder based on the plurality of attention matrices to provide a trained autoencoder and/or generating (e.g., by model analysis system 102) a respective latent representation for each respective attention matrix of the plurality of attention matrices based on the trained autoencoder. In some non-limiting embodiments or aspects, the respective latent representation for each respective attention matrix may include the respective embedding for each respective attention matrix. In some non-limiting embodiments or aspects, generating the respective embedding for each respective attention matrix of the plurality of attention matrices may further include generating (e.g., by model analysis system 102) the respective embedding for each respective attention matrix of the plurality of attention matrices based on applying t-distributed stochastic neighbor embedding (tSNE) for each latent representation of each respective attention matrix of the plurality of attention matrices.

As shown in FIG. 2, at step 216, process 200 may include generating a graphical user interface. For example, model analysis system 102 may generate a graphical user interface including at least one view.

In some non-limiting embodiments or aspects, the at least one view may include at least one of: a head importance view, a head attention strength view, a head attention pattern view, an image overview view, or any combination thereof.

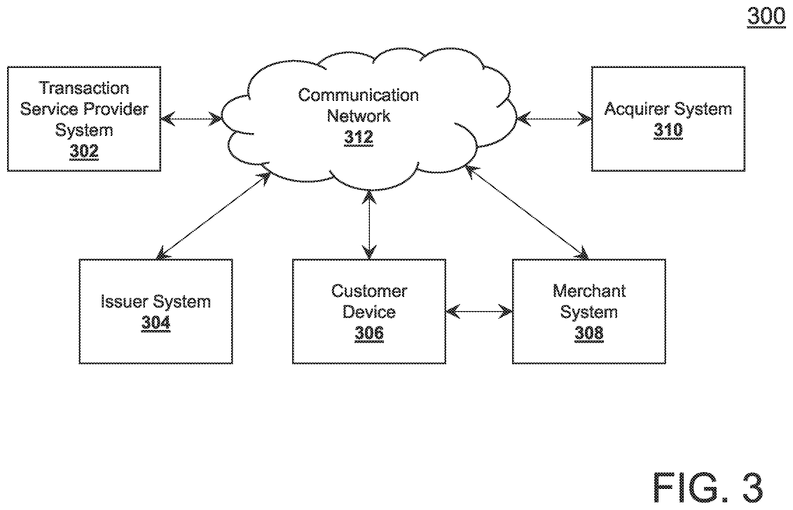

Referring now to FIG. 3, shown is a diagram of a non-limiting embodiment or aspect of an exemplary environment 300 in which systems, products, and/or methods, as described herein, may be implemented. As shown in FIG. 3, environment 300 may include transaction service provider system 302, issuer system 304, customer device 306, merchant system 308, acquirer system 310, and communication network 312. In some non-limiting embodiments or aspects, at least one of (e.g., both of) model analysis system 102 and/or machine learning model 104 may be implemented by (e.g., part of) transaction service provider system 302. In some non-limiting embodiments or aspects, at least one of (e.g., both of) model analysis system 102 and/or machine learning model 104 may be implemented by (e.g., part of) another system, another device, another group of systems, or another group of devices, separate from or including transaction service provider system 302, such as issuer system 304, customer device 306, merchant system 308, acquirer system 310, and/or the like.

Transaction service provider system 302 may include one or more devices capable of receiving information from and/or communicating information to issuer system 304, customer device 306, merchant system 308, and/or acquirer system 310 via communication network 312. For example, transaction service provider system 302 may include a computing device, such as a server (e.g., a transaction processing server), a group of servers, and/or other like devices. In some non-limiting embodiments or aspects, transaction service provider system 302 may be associated with a transaction service provider as described herein. In some non-limiting embodiments or aspects, transaction service provider system 302 may be in communication with a data storage device, which may be local or remote to transaction service provider system 302. In some non-limiting embodiments or aspects, transaction service provider system 302 may be capable of receiving information from, storing information in, communicating information to, or searching information stored in the data storage device.

Issuer system 304 may include one or more devices capable of receiving information and/or communicating information to transaction service provider system 302, customer device 306, merchant system 308, and/or acquirer system 310 via communication network 312. For example, issuer system 304 may include a computing device, such as a server, a group of servers, and/or other like devices. In some non-limiting embodiments or aspects, issuer system 304 may be associated with an issuer institution as described herein. For example, issuer system 304 may be associated with an issuer institution that issued a credit account, debit account, credit card, debit card, and/or the like to a user associated with customer device 306.

Customer device 306 may include one or more devices capable of receiving information from and/or communicating information to transaction service provider system 302, issuer system 304, merchant system 308, and/or acquirer system 310 via communication network 312. Additionally or alternatively, each customer device 306 may include a device capable of receiving information from and/or communicating information to other customer devices 306 via communication network 312, another network (e.g., an ad hoc network, a local network, a private network, a virtual private network, and/or the like), and/or any other suitable communication technique. For example, customer device 306 may include a client device and/or the like. In some non-limiting embodiments or aspects, customer device 306 may or may not be capable of receiving information (e.g., from merchant system 308 or from another customer device 306) via a short-range wireless communication connection (e.g., an NFC communication connection, an RFID communication connection, a Bluetooth® communication connection, a Zigbee® communication connection, and/or the like), and/or communicating information (e.g., to merchant system 308) via a short-range wireless communication connection.

Merchant system 308 may include one or more devices capable of receiving information from and/or communicating information to transaction service provider system 302, issuer system 304, customer device 306, and/or acquirer system 310 via communication network 312. Merchant system 308 may also include a device capable of receiving information from customer device 306 via communication network 312, a communication connection (e.g., an NFC communication connection, an RFID communication connection, a Bluetooth® communication connection, a Zigbee® communication connection, and/or the like) with customer device 306, and/or the like, and/or communicating information to customer device 306 via communication network 312, the communication connection, and/or the like. In some non-limiting embodiments or aspects, merchant system 308 may include a computing device, such as a server, a group of servers, a client device, a group of client devices, and/or other like devices. In some non-limiting embodiments or aspects, merchant system 308 may be associated with a merchant as described herein. In some non-limiting embodiments or aspects, merchant system 308 may include one or more client devices. For example, merchant system 308 may include a client device that allows a merchant to communicate information to transaction service provider system 302. In some non-limiting embodiments or aspects, merchant system 308 may include one or more devices, such as computers, computer systems, and/or peripheral devices capable of being used by a merchant to conduct a transaction with a user. For example, merchant system 308 may include a POS device and/or a POS system.

Acquirer system 310 may include one or more devices capable of receiving information from and/or communicating information to transaction service provider system 302, issuer system 304, customer device 306, and/or merchant system 308 via communication network 312. For example, acquirer system 310 may include a computing device, a server, a group of servers, and/or the like. In some non-limiting embodiments or aspects, acquirer system 310 may be associated with an acquirer as described herein.

Communication network 312 may include one or more wired and/or wireless networks. For example, communication network 312 may include a cellular network (e.g., a long-term evolution (LTER) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 3 are provided as an example. There may be additional systems, devices, and/or networks; fewer systems, devices, and/or networks; different systems, devices, and/or networks; and/or differently arranged systems, devices, and/or networks than those shown in FIG. 3. Furthermore, two or more systems or devices shown in FIG. 3 may be implemented within a single system or device, or a single system or device shown in FIG. 3 may be implemented as multiple, distributed systems or devices. Additionally or alternatively, a set of systems (e.g., one or more systems) or a set of devices (e.g., one or more devices) of environment 300 may perform one or more functions described as being performed by another set of systems or another set of devices of environment 300.

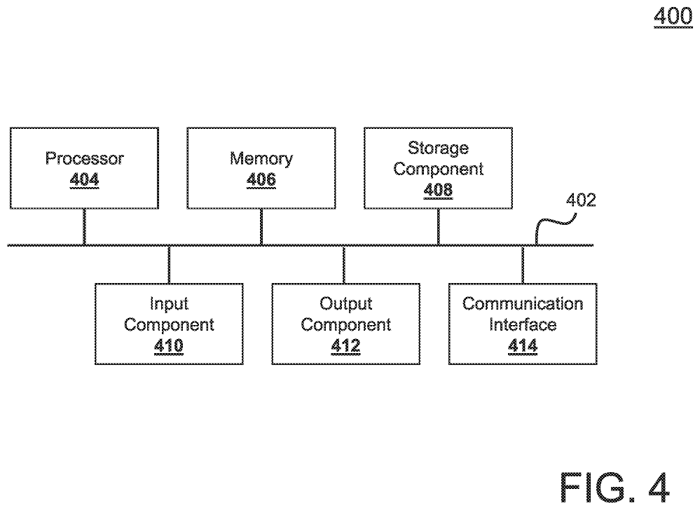

Referring now to FIG. 4, shown is a diagram of example components of a device 400 according to non-limiting embodiments or aspects. Device 400 may correspond to at least one of model analysis system 102 and/or machine learning model 104 in FIG. 1 and/or at least one of transaction service provider system 302, issuer system 304, customer device 306, merchant system 308, and/or acquirer system 310 in FIG. 3, as an example. In some non-limiting embodiments or aspects, such systems or devices in FIG. 1 or FIG. 3 may include at least one device 400 and/or at least one component of device 400. The number and arrangement of components shown in FIG. 4 are provided as an example. In some non-limiting embodiments or aspects, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

As shown in FIG. 4, device 400 may include bus 402, processor 404, memory 406, storage component 408, input component 410, output component 412, and communication interface 414. Bus 402 may include a component that permits communication among the components of device 400. In some non-limiting embodiments or aspects, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404.

With continued reference to FIG. 4, storage component 408 may store information and/or software related to the operation and use of device 400. For example, storage component 408 may include a hard disk (e.g., a magnetic disk, an optical disk, a magneto-optic disk, a solid state disk, etc.) and/or another type of computer-readable medium. Input component 410 may include a component that permits device 400 to receive information, such as via user input (e.g., a touch screen display, a keyboard, a keypad, a mouse, a button, a switch, a microphone, etc.). Additionally, or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices. Further, the term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

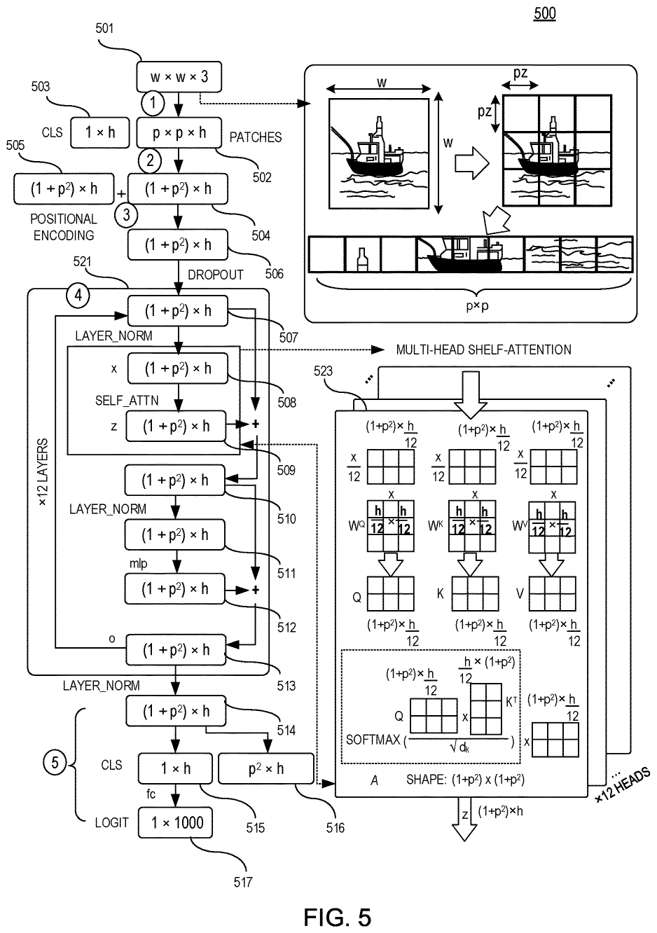

Referring now to FIG. 5, shown is a schematic diagram of a ViT model 500, according to some non-limiting embodiments or aspects.

In some non-limiting embodiments or aspects, input image 501 has a size of w×w×3 (e.g., w pixels width, w pixels height, and 3 colors (e.g., red, green, blue (RGB))). At step 1, input image 501 is decomposed into a sequence of patch tokens 502 (e.g., as shown in the inset box at the top right of FIG. 5). For the purpose of illustration, assuming the width and height of input image 501 are the same, denoted as w, if the patch size is pz×pz, the number of patches will be

$${p}^{2} = \frac{w}{pz} \times \frac{w}{pz} .$$

In some non-limiting embodiments or aspects, the patches may be arranged into a sequence, and each patch may be encoded as an h-dimensional (hD) vector.

In some non-limiting embodiments or aspects, at step 2, an hD class token (CLS) 503 may be zero-initialized, and CLS token 503 may be concatenated with patch tokens 502, resulting in matrix 504 having dimensions (1+p²)×h. In some non-limiting embodiments or aspects, CLS token 503 may learn class-related features over training and be used to generate the class probability.

In some non-limiting embodiments or aspects, at step 3, positional encodings 505 may be zero-initialized and/or added to matrix 504 (e.g., to provide matrix 506). In some non-limiting embodiments or aspects, positional encodings 505 may learn the positional information of each patch over training.

In some non-limiting embodiments or aspects, at step 4, matrix 506 may be inputted to l stacked attention layers 521. For the purpose of illustration, FIG. 5 shows one attention layer 521 for brevity, and FIG. 5 includes a notation that there would be multiple such attention layers 521 (e.g., 12 layers) in ViT model 500. Each attention layer 521 may include n heads 523 of a multi-head self attention model. For the purpose of illustration, FIG. 5 shows one head 523 for brevity, and FIG. 5 includes a notation that there would be multiple such heads 523 (e.g., 12 heads) in each attention layer 521.

In some non-limiting embodiments or aspects, matrix may be inputted to a dropout layer to provide matrix 507. Matrix 507 may be inputted to a layer normalization layer to provide matrix 508. Matrix 508 may be inputted into the multi-head self attention model. For example, matrix 508 (which may be denoted as input x) may be divided into n portions (e.g., divided into 12 portions, each denoted as

$$\frac{x}{12} ,$$

which may have shape (1+p²)×h). Each respective portion

$$\frac{x}{12}$$

may be inputted to a respective head 523 of the multi-head self attention model. The respective portion

$$\frac{x}{12}$$

may be transformed based on learnable weight matrices W^{Q}, W^{K}, W^{V} into query (Q), key (K), and value (V) matrices, respectively. As such, the self-attention may be determined based on the following equation:

$$Attention ( Q , K , V ) = A \cdot V = softmax ( \frac{{QK}^{T}}{\sqrt{{d}_{K}}} ) \cdot V , \qquad Equation l$$

where the attention weight A may have size (1+p²)×(1+p²) and/or may represent the pair-wise attention strength between all (1+p²) tokens. In some non-limiting embodiments or aspects, each patch may attend to other patches and may be attended to by others. For brevity, patches may be referred to as source patches when they are being attended to, and may be referred to as target patches when they attend to others.

In some non-limiting embodiments or aspects, the output matrix 509 of the multi-head self-attention model may be referred to as z. In some non-limiting embodiments or aspects, self-attention computations are conducted in all n heads (e.g., in parallel), and the resulting attentions may be concatenated and linearly transformed to generate the final multi-head self-attention z (e.g., output matrix 509). For example, z may be determined based on the following equation:

z=Concat(head₁,head₂, . . . ,headₙ)·W^{O}+b, Equation 2

where headᵢ=Attention (Qᵢ, Kᵢ, Vᵢ), W^{O} is a learnable weight matrix (e.g., for the linear transformation), and b is a learnable bias (e.g., for the linear transformation).

In some non-limiting embodiments or aspects, output matrix 509 may be combined with (e.g., added to) matrix 507 via a skip-connection to provide matrix 510. Matrix 510 may be inputted to a layer normalization layer to provide matrix 511, which may be inputted to a multi-layer perception (MLP) layer to provide matrix 512. Matrix 512 may be combined with (e.g., added to) matrix 510 via a skip-connection to provide matrix 513. In some non-limiting embodiments or aspects, matrix 513 may be referred to as output o of attention layer 521. For example, output o may have shape (1+p²)×h, and/or output o may be associated with an updated hD representation for the patches (e.g., 1+p² patches, including the p² image patches and CLS token). In some non-limiting embodiments or aspects, the output o for each attention layer 521 may be fed back (e.g., inputted) as the input to the next attention layer 521, and the process for each layer will repeat until the last attention layer 521 is reached. For example, if there are l stacked attention layers 521 that each have n heads 523, there will be a total of l×n heads 523, and each head 523 may have its own attention weight matrix A (e.g., recording the learned attention between patches at that head 523 of that attention layer 521).

In some non-limiting embodiments or aspects, the output o (e.g., output matrix 509) of the last attention layer 521 may be inputted to a layer normalization layer to provide matrix 514. For example, matrix 514 may have shape (1+p²)×h, and/or matrix 514 may be associated with a normalized hD representation for the patches (e.g., 1+p² patches, including the p² image patches and CLS token).

In some non-limiting embodiments or aspects, at step 5, CLS token embedding 515 may be used for prediction. For example, the learned CLS token embedding 515 may be decoupled from the patch token embeddings 516. Additionally or alternatively, CLS token embedding 515 may be transformed into class logits 517 (e.g., based on fully connected layers fc). For example, CLS token embedding 515 may be inputted to fully connected layers fc to provide class logits 517. In some non-limiting embodiments or aspects, the class prediction (e.g., image classification) may be determined (e.g., generated) based on class logits 517.

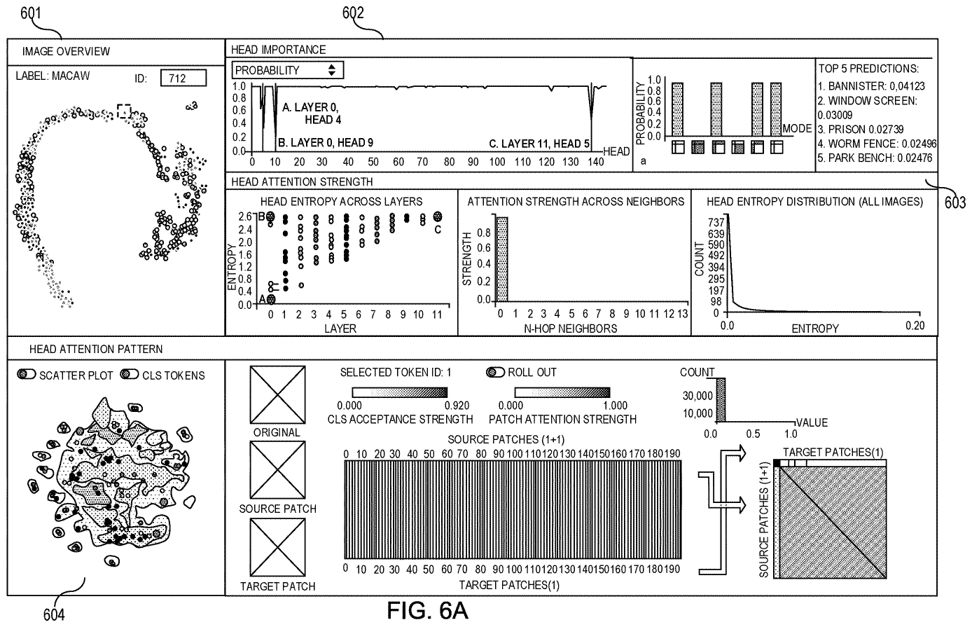

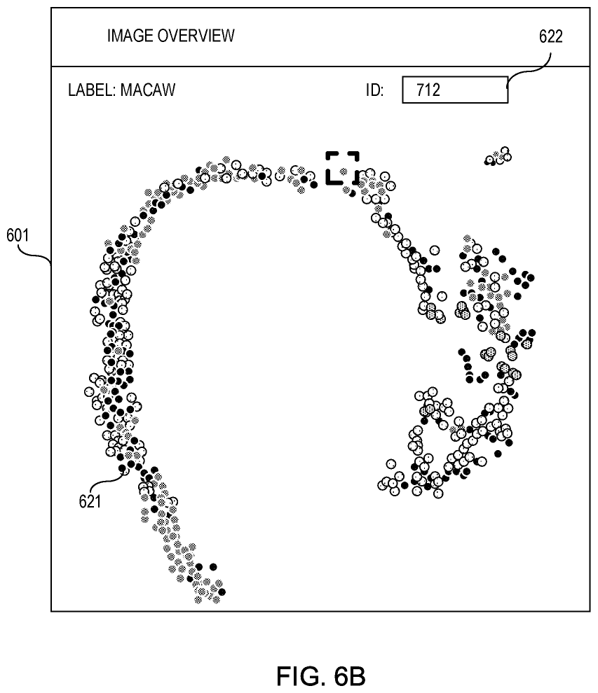

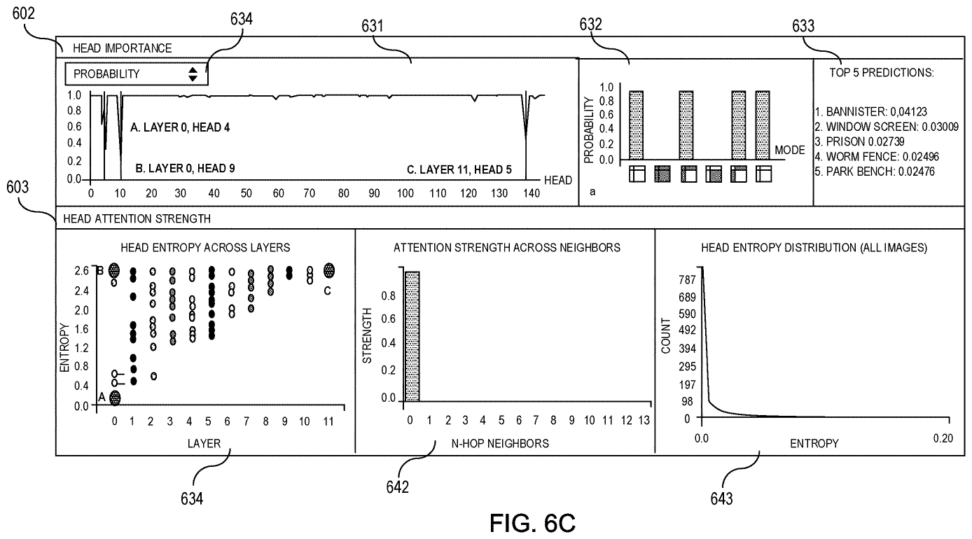

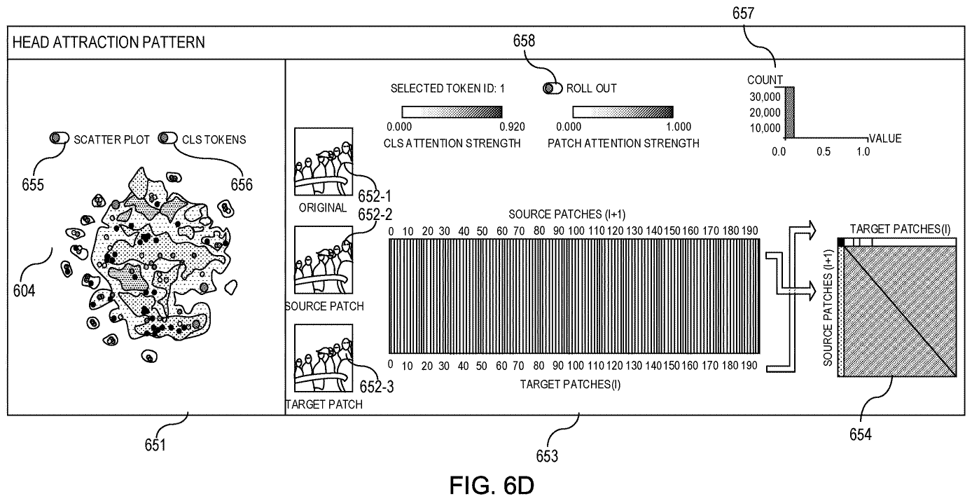

FIGS. 6A-6D are screenshots of an example graphical user interface (GUI) 600, according to some non-limiting embodiments or aspects. As shown in FIG. 6A, GUI 600 may include at least one of image overview view 601, head importance view 602, head attention strength view 603, head attention pattern view 604, and/or any combination thereof. The number, arrangement, and appearance of views shown in FIG. 6A are provided as an example. There may be additional views, fewer views, different views, and/or differently arranged views than those shown in FIG. 6A. FIG. 6B shows an enlarged screenshot of image overview view 601 from FIG. 6A. FIG. 6C shows an enlarged screenshot of head importance view 602 and head attention strength view 603 from FIG. 6A. FIG. 6D shows an enlarged screenshot of head attention pattern view 604 from FIG. 6A.

As shown in FIGS. 6A and 6B, image overview view 601 may use tSNE and scatterplot 621 to provide an overview of the test samples (e.g., images). For example, each point in scatterplot 621 may represent an image, and the color and/or shading of the point may denote a class label. For the purpose of illustration, the coordinates of each point may be decided by the dimensionality reduction result of the corresponding image's ultimate head importance, which may be an (l×n)-dimensional vector, as described herein. For example, each dimension of the vector may reflect the corresponding head's importance. The tSNE layout based on this vector may cluster images (e.g., points representative of images) with similar head-importance together in scatterplot 621, which may help to guide a users' exploration (e.g., selection of points/images of interest within scatterplot 621 of image overview view 601). For example, as shown in FIGS. 6A and 6B, there may be a small cluster on the top-right corner, which may catch a user's attention during exploration. A certain head (e.g., head 9) may be important (e.g., dominantly important with respect to other heads) to this cluster.

In some non-limiting embodiments or aspects, clicking on any point in scatterplot 621 or providing an identifier number (ID) in the top-right textbox 622 may select (e.g., highlight, surround with a box, and/or the like) the corresponding image and/or may dynamically generate and/or update the following three views (e.g., head importance view 602, head attention strength view 603, and/or head attention pattern view 604) based on the selected point (e.g., for analysis from the three perspectives).

As shown in FIGS. 6A and 6C, head importance view 602 may include line graph 631, bar graph 632, listing of predictions 633 (e.g., top 5 predictions), and/or any combination thereof.

In some non-limiting embodiments or aspects, different metrics to quantify the importance of a head to a ViT may be utilized. For example, metrics may be generated through a leave-one-out ablation strategy, e.g., encoding a head's importance based on the magnitude of changes in the final output (e.g., ultimate importance) or the magnitude of changes in the next-layer's embeddings (e.g., immediate importance) after pruning the head. In some non-limiting embodiments or aspects, pruning a head may include setting its attention matrix (e.g., A in Equation 1) to 0.

In some non-limiting embodiments or aspects, multiple (e.g., two) different ultimate importance metrics for each head may be used. For example, a first metric may reflect the probability change of the true class (see, e.g., Equation 3), and a second metric may encode the Jensen-Shannon Divergence (JSD) between the two probability distributions (see, e.g., Equation 4) before and after a head is pruned. For the purpose of illustration, assume a well-trained ViT model may be denoted as ViT( ) and may receive an image img as input and output a probability distribution P (e.g., P=ViT(img)). Additionally, ViT_{i,j}( ) may denote the jth head from the ith layer has been pruned, and as such, P_{i,j}=ViT_{i,j}(img). idx_{label} may denote the index of the class label of the image img. For the purpose of illustration, the first and second importance metrics (e.g., probability change importance metric

$${I}_{i , j}^{prob}$$

and JSD importance metric

$${I}_{i , j}^{JSD} )$$

of the head (i, j) may be determined based on the following equations:

$${I}_{i , j}^{prob} = P [ {idx}_{label} ] - {P}_{i , j} [ {idx}_{label} ] \qquad Equation 3$$

$${I}_{i , j}^{JSD} = J S D ( P \vert \vert {P}_{i , j} ) \qquad Equation 4$$

In some non-limiting embodiments or aspects, it may be beneficial to have an immediate importance metric in addition to an ultimate importance metric. For example, observing only the ultimate changes in final probabilities may not be sufficient because pruning a head may significantly change the corresponding layer's output (e.g., z in Equation 2) while causing only a minor change to the final probabilities. This may occur because some heads with similar behaviors from later layers may complement the contribution of the pruned head, concealing its importance. As such, at least one (e.g., two) immediate important metrics (e.g., a layer importance metric) may be determined for each head (e.g., based on the at least one layer output and the at least one respective pruned layer output for the respective attention head). For example, such metrics may be determined based on the cosine distance (e.g., [symbol] ( )) between the output of the immediate attention layer before and after the head is pruned, which may be denoted as z and z′, respectively. For example, the layer output z may be a (1+p²)×h matrix, which may contain the latent representations/embeddings for the CLS token (e.g., the first 1×h) and patch tokens (e.g., the later (p²×h)). For the purpose of illustration, the following two immediate importance metrics

$$( e . g . , {I}_{i , j}^{CLS} and {I}_{i , j}^{patch} )$$

may measure the importance of the CLS token and patch tokens, respectively. For the CLS token, the importance metric may be determined based on the cosine distance between the two CLS token embeddings. For patch tokens, the importance metric may be determined based on the average of cosine distances over all patches. These immediate importance metrics

$$( e . g . , {I}_{i , j}^{CLS} and {I}_{i , j}^{patch} )$$

may be determined based on the following equations:

$${I}_{i , j}^{CLS} = {𝒟}_{cos} ( z [ 0 ] , {z}^{′} [ 0 ] ) \qquad Equation 5$$

$${I}_{i , j}^{patch} = avg ( [ {𝒟}_{cos} ( z [ i + 1 ] , {z}^{′} [ i + 1 ] ) for i in range ( {p}^{2} ) ] ) \qquad Equation 6$$

where z[0] is the hD CLS embedding and z[1:] is the p² patch embedding.

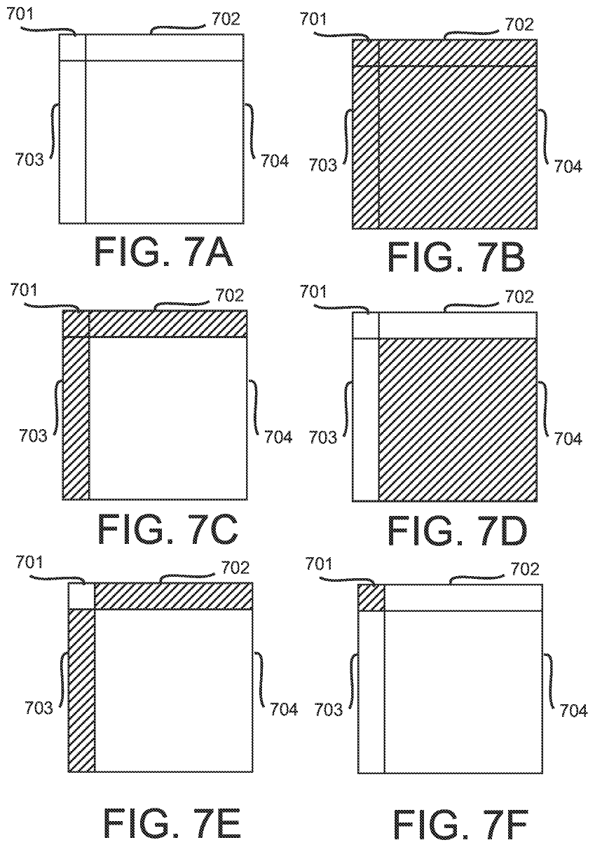

Referring now to FIGS. 7A-7F, and with continued reference to FIGS. 6A-6D, FIGS. 7A-7F are diagrams of different pruning modes, according to some non-limiting embodiments or aspects.

In some non-limiting embodiments or aspects, after important heads are identified using the metrics described herein (e.g., the four importance metrics in Equations 3-6), the importance of the heads may be further dissected by partially pruning the heads. For the purpose of illustration, FIGS. 7A-7F show six partial pruning modes. For example, the attention matrix from each head may be divided into four regions based on the types of source and target tokens: first region 701 (e.g., CLS→CLS), second region 702 (e.g., CLS→patches), third region 703 (e.g., patches→CLS), and fourth region (e.g., patches→patches). In some non-limiting embodiments or aspects, second region 702 (e.g., CLS→patches) and third region 703 (e.g., patches→CLS) may be considered together because they both encode the interactions between the CLS and patch tokens. The pruning modes may be defined by setting one or more regions of the attention matrix to zeros (e.g., as denoted by diagonal pattern in FIGS. 7B-7F). For the purpose of illustration, mode 0 (e.g., FIG. 7A) may be the original scenario where the head is not pruned. Mode 1 (e.g., FIG. 7B) may prune the head completely. Modes 2-5 include additional cases where only the patterned (e.g., diagonal patterned) regions are pruned. Showing performance change from these pruning models may attribute the head's importance to individual regions.

Referring again to FIGS. 6A and 6C, head importance view 602 may visualize the proposed metrics and pruning modes. For example, line graph 631 may present the one or more importance metrics (e.g., one of the four head-importance metrics, as selected from the dropdown menu 634) for a selected image/point. The horizontal axis may represent all the l×n heads from the selected image, and the vertical axis may denote the value of the selected importance metric (e.g., selected from dropdown menu 634).

In some non-limiting embodiments or aspects, for

$${I}_{i , j}^{prob} ,$$

the probability value P_{i,j}[idx_{label}] may be displayed (e.g., instead of the difference in Equation 3), as this probability value may appear more intuitive to a user.

In some non-limiting embodiments or aspects, when no image instances is selected (e.g., at the beginning of exploration), the line in this view may show the average value of the selected metrics aggregated over all images.

In some non-limiting embodiments or aspects, a band (e.g., lightly colored and/or lightly shaded band) surrounding the line may be used to denote the standard deviation of the metric values.

In some non-limiting embodiments or aspects, the aggregated mean curve and standard deviation band may provide the global importance for the l×n heads, which may provide insight for users to select globally important heads. When an image is selected (e.g., from image overview view 601), line graph 631 may show the local importance of individual heads to the selected image.

In some non-limiting embodiments or aspects, a head may be selected from line graph 631 (e.g., by dragging a vertical line). In response to selection of a head, bar graph 632 may show the selected importance metric (e.g., on the vertical axis) for different pruning modes (e.g., on the horizontal axis). For example, this may allow for further dissecting the head's importance. For the purpose of illustration, as shown in FIGS. 6A and 6C, bar graph 632 may show that the importance of the selected head originates from the patch tokens (e.g., solely and/or dominantly) and pruning CLS-related attention shows little (e.g., no) impact.

In some non-limiting embodiments or aspects, listing of predictions 633 may show the top predictions (e.g., top 5 predictions) of the selected image with/without head pruning. For example, listing of predictions 633 may include a class name and/or a probability value for each of the top 5 predictions. In some non-limiting embodiments or aspects, a true label of the image may be denoted by changing a text (e.g., bolding, italicizing, and/or underlining) one of the predictions. In some non-limiting embodiments or aspects, listing of predictions 633 may assist in understanding the predictions.

With continued reference to FIGS. 6A and 6C, head attention strength view 603 may include scatterplot 641, bar graph 642, area plot 643, or any combination thereof.

In some non-limiting embodiments or aspects, the attention strength of a head may characterize the spatial distributions of the attention strength across all patches, which may explain why the head is important by indicating where the head makes the patches focus on. For example, a p-dimensional (pD) attention strength vector s may be determined for each head. The attention strength vector s may indicate the average attention strength of all patches (in the head) to their k-hop neighbors (k∈[0, p−1]). For the purpose of illustration, the attention strength vector s may be determined based on the following equations:

$$s = \frac{1}{{p}^{2}} {\sum }_{i} {\sum }_{j} {s}^{( i , j )} , i ∈ [ 0 , p - 1 ] , j ∈ [ 0 , p - 1 ] \qquad Equation 7$$

$${s}^{( i , j )} = < {s}_{0}^{( i , j )} , {s}_{1}^{( i , j )} , {s}_{2}^{( i , j )} , … , {s}_{p - 1}^{( i , j )} > , \qquad Equation 8$$

$$where {s}_{k}^{( i , j )}$$

denotes the average attention from patch (i, j) to its k-hop neighbors in the two-dimensional (2D) domain.

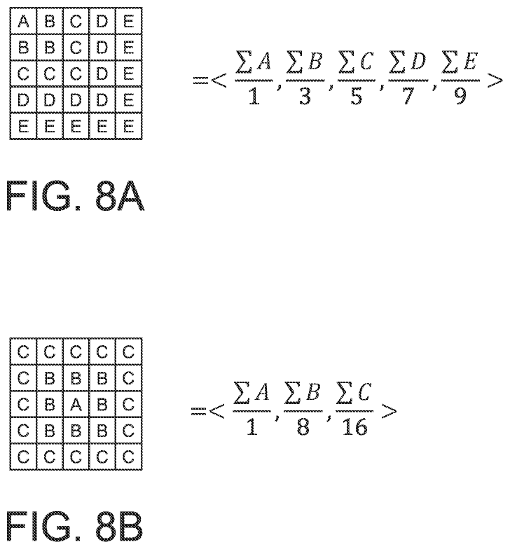

Referring now to FIGS. 8A and 8B, and with continued reference to FIGS. 6A-6D, FIGS. 8A and 8B are diagrams showing generation of attention strength vectors, according to some non-limiting embodiments or aspects. For the purpose of illustration, as shown in FIGS. 8A and 8B, p=5.

As shown in FIG. 8A, starting with patch (0,0) (e.g., the patch marked A in the diagram),

$${s}_{0}^{( 0 , 0 )}$$

(e.g., the 0-hop attention strength) may be the attention that patch (0,0) paid to itself, and

$${s}_{1}^{( 0 , 0 )}$$

(e.g., the 1-hop attention strength) may be the sum of the attentions paid to its 1-hop neighbors (e.g., marked B in the diagram) divided by the number of 1-hop neighbors (e.g., 3).

$${s}_{2}^{( 0 , 0 )}$$

(e.g., the 2-hop attention strength) may be the sum of the attentions paid to its 2-hop neighbors (e.g., marked C in the diagram) divided by the number of 2-hop neighbors (e.g., 5), and so on. As such, a pD vector (e.g., s^{(0,0)}) is determined for patch (0,0).

As shown in FIG. 8B, starting with patch (2,2) (e.g., the patch marked A in the diagram),

$${s}_{0}^{( 2 , 2 )}$$

(e.g., the 0-hop attention strength) may be the attention that patch (2,2) paid to itself, and

$${s}_{1}^{( 2 , 2 )}$$

(e.g., the 1-hop attention strength) may be the sum of the attentions paid to its 1-hop neighbors (e.g., marked B in the diagram) divided by the number of 1-hop neighbors (e.g. 8).

$${s}_{2}^{( 2 , 2 )}$$

(e.g., the 2-hop attention strength) may be the sum of the attentions paid to its 2-hop neighbors (e.g., marked C in the diagram) divided by the number of 2-hop neighbors (e.g., 16). For the purpose of illustration, patch (2,2) may not have 3- or 4-hop neighbors (e.g., unlike patch (0,0), which has 3- and 4-hop neighbors). As such,

$${s}_{3}^{( 2 , 2 )} and {s}_{4}^{( 2 , 2 )}$$

may not be counted when computing the corresponding element of vector s.

As such, attention strength vectors may be generated for all patches, resulting in p² attention strength vectors (e.g., of size pD).

Referring again to FIGS. 6A and 6C, attention strength view 603 may present the attention strength of all heads with multiple (e.g., three) visual components. For example, a first visual component (e.g., scatterplot 641) of attention strength view 603 may present an overview of all heads for the selected image through scatterplot 641. Each point in scatterplot 641 may be representative of a respective head. The horizontal axis may be associated with the layer of the ViT model, and the horizontal position (and/or color and/or shading) of each point in scatterplot 641 may reflect the layer that the head is from. The vertical axis may be associated with entropy, and the vertical position of each point in scatterplot 641 may reflect the entropy of the head's attention strength vector s. For example, the entropy of s may reflect if the head's attention strength is localized on certain hop neighbors (e.g., low-entropy, the value of one element dominates the strength vector s) or spread across all k-hop neighbors (e.g., high-entropy, the values of all elements of strength vector s are similar). As such, this first visual component (e.g., scatterplot 641) may depict a trend of the heads across layers. For example, as shown in FIGS. 6A and 6C, heads from higher layers may attend more evenly to all patches, whereas lower-layer heads may attend either locally or globally.

In some non-limiting embodiments or aspects, a head may be selected by selecting (e.g., clicking and/or the like) the corresponding point in scatterplot 641. In response to selection of a head, the attention strength vector s of the selected head may be displayed in a second visual component (e.g., bar graph 642). For example, as shown in FIGS. 6A and 6C, all patches in the selected head may attend only to themselves (e.g., all attention strength are on the 0-hop neighbors).

In some non-limiting embodiments or aspects, a third visual element (e.g., area plot 643) may present the distribution of entropy values for the selected head over all images. For example, as shown in FIGS. 6A and 6C, the currently selected head may have a small entropy (e.g., as shown in scatterplot 641), and all patches may attend to 0-hop neighbors only (e.g., as shown in bar graph 642). Area plot 643 may further show the head has consistently low-entropy across all images, as the area is distributed (e.g., predominantly distributed) on the left corner. In some non-limiting embodiments or aspects, a vertical line over area plot 643 may mark the head's entropy for the currently selected image. For example, such a line, in the context of area plot 643, may reflect how much the head's attention strength for the current image varies from its strength for other images.

Referring now to FIGS. 6A and 6D, head attention pattern view 604 may include density plot 651, images 652-1 through 652-3 (collectively “images 652” and individually “image 652”), token connection chart 653, and heat map 654.

In some non-limiting embodiments or aspects, the attention pattern of a head may reflect how tokens are attending to others, including both the CLS token and the patch tokens. Summarizing the possible patterns of all heads (e.g., especially the important heads) may help to deepen the understanding on how ViT works and interpret why certain heads are more important.

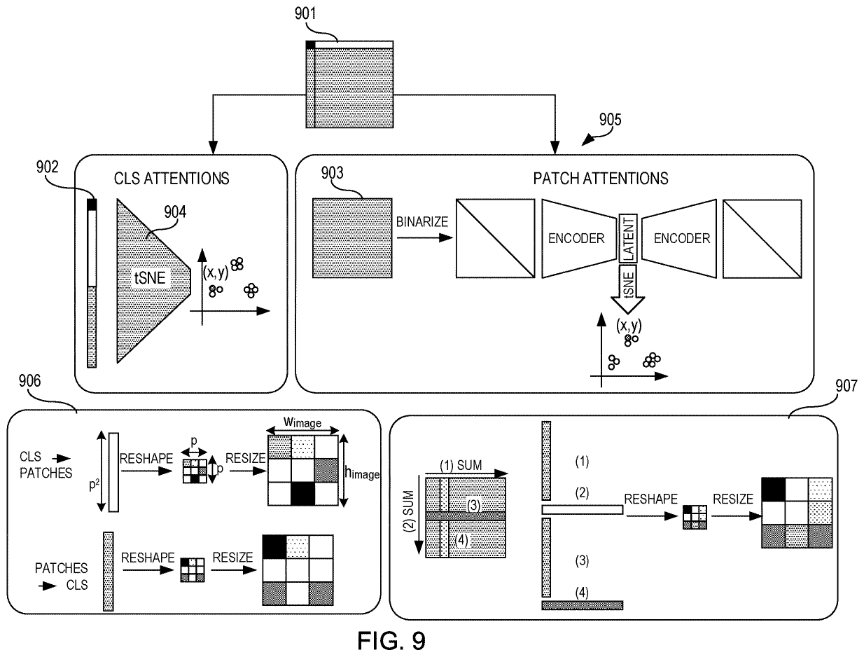

In some non-limiting embodiments or aspects, due to the functionality difference between CLS and patch tokens, these types of tokens may be treated separately. For example, given an input image and one of its heads, the corresponding attention matrix A may be of shape (1+p²)×(1+p²), as described herein. The attention matrix A may be separated into CLS-related attentions A_{CLS}=Concat (A[0, :], A[1:, 0])∈ [symbol] and patch-related attentions A_{patch}=A [1:, 1:]∈ [symbol] . For the purpose of illustration, referring now to FIG. 9, and with continued reference to FIGS. 6A and 6D, FIG. 9 is a schematic diagram of separating the attention matrix 901 into CLS-related attentions vector 902 and patch-related attention matrix 903.

In some non-limiting embodiments or aspects, for CLS attention patterns, the CLS-related attentions A_{CLS} (e.g., CLS-related attentions vector 902) may concatenate the CLS→CLS, CLS→Patches, and Patches→CLS regions of attention matrix A, as described herein, and Acts may have size (2p²+1). For the purpose of illustration, assuming m images, each image may generate l×n attention matrices from the l×n heads, and as such, m×l×n such vectors may be generated. Using tSNE 904, the vectors may be projected into 2D and presented with a scatterplot and/or density plot (e.g., density plot 651). In some non-limiting embodiments or aspects, attention heads with similar CLS attention patterns may be clustered together.

In some non-limiting embodiments or aspects, for patch attention patterns, patch-related attentions A_{patch} (e.g., patch-related attention matrix 903) may be subjected to an antoencoder (AE)-based learning technique. For example, instead of magnitude, A_{patch} may be binarized using a cutoff (e.g., because attention pattern may be more interesting and/or useful than magnitude), for example, setting a cutoff that the top 1% of values go to 1 and the rest go to 0. This binarization may enhance the attention patterns and/or makes them more easily learnable. Second, using the m×l×n binarized A_{patch}, AE model 905 may be trained. For example, AE model 905 may include two symmetric subnetworks (e.g., the encoder network and the decoder network, with a latent space/layer in the middle), each of which may include multiple (e.g., two) convolutional layers and/or one fully-connected layer. Third, using the latent representations (e.g., from the latent space/layer) from the well-trained AE model 905 (e.g., as an intermediate output), tSNE layout may be conducted based on the latent representations. The tSNE layout may show clusters, which may expose different attention patterns.

In some non-limiting embodiments or aspects, the attention matrix A may reflect the attention between neighboring attention layers. If a head is from the third layer or above, the tokens that head attends to may no longer be the raw tokens (e.g., from image patches), but the aggregation of all raw tokens. For example,

$${A}_{l}^{h}$$

may be the attention matrix from the head h of layer l.

$${\overline{A}}_{l} = {\sum }_{h} {A}_{l}^{h}$$

my be the average attention matrix from all the n heads of layer l. For the purpose of illustration, Ā₂[i, j] may denote the average attention from token i to j from layer 2 to layer 1. Token i may be a sky patch and token j may be a sea patch from the image. However, token j from layer 1 may contain information from not only the sea patch, as it may aggregate all tokens from layer 0. In some non-limiting embodiments or aspects, to reveal the attention of a token from layer (>=2 to the input token at layer l=0, attention rollout may include multiplying all average attentions from layer l to layer 0, i.e., Ãₗ=ĀₗĀₗ₋₁ . . . Ā₁, which may reflect the accumulated attention. For example, Ã₂[i, j] may aggregate all attentions that start from layer 2 token i and end at layer 0 token j. To extend attention rollout and reflect the attention of tokens from a head of layer l to layer 0,

$${\tilde{A}}_{l}^{h}$$

may be based on the multiplication between the attention from head h of layer l and the attention rollout result of all l−1 layers

$$( e . g . , {\tilde{A}}_{l}^{h} = {A}_{l}^{h} {\tilde{A}}_{l - 1} ) .$$

In some non-limiting embodiments or aspects, density plot 651 may be switched to a scatterplot (e.g., based on toggle 655). Density plot 651 (or the scatterplot, if the switch is made) may present all heads from all images based on tSNE, as described herein. The tSNE layout could be either for the CLS attentions (A_{CLS}) or for the patch attentions (A_{patch}), e.g., based on toggle 656. When density plot is selected (e.g., based on toggle 655), the background density contours in density plot 651 may present the distribution of all the m×l×n heads. In some non-limiting embodiments or aspects, when an image of interest is selected from image overview view 601, its l×n heads may be shown on top of the density plots as points, and the color and/or shading of each point may denote the layer that the corresponding head is from.

In some non-limiting embodiments or aspects, the details of the attention matrix for a selected head (selected by clicking the point in density plot 651) may be shown in images 652, token connection chart 653, and/or heat map 654. For example, an attention matrix may denote the attention between (1+p²) tokens. For the purpose of illustration, token connection chart 653 may depict the tokens as two rows of (1+p²) tokens (e.g., source tokens on top, target tokens on bottom). The lines in token connection chart 653 may use light to dark color and/or shading to encode the attention magnitude. Additionally or alternatively, different colors (e.g., blue and orange) and/or different shading may be used to denote A_{CLS} and A_{patch}, respectively. In some non-limiting embodiments or aspects, showing all the (1+p²)×(1+p²) lines would make the view very cluttered, so a user may specify a threshold, and the lines with associated attention value below the threshold may be disabled (e.g., hidden). As shown in FIGS. 6A and 6D, histogram 657 may show the distribution of the (1+p²)×(1+p²) values, which may provide guidance for users to set the threshold (e.g., by dragging a vertical bar on top of histogram 657). For the purpose of illustration, the threshold as shown in FIGS. 6A and 6D may be 1%, which may indicate only the top 1% of lines are visible. For example, from the visualization of the vertical line patterns between the two rows, it can be seen that all tokens (both CLS and patch tokens) attend to themselves.

In some non-limiting embodiments or aspects, the attention matrix may be presented through heat map 654 (e.g., with source tokens as rows and target tokens as columns). In some non-limiting embodiments or aspects, heat map 654 may have the same regions as illustrated in FIGS. 7A-7F (e.g., first region for CLS→CLS, second region for CLS→patches, third region for patches→CLS, and fourth region for patches→patches). For the purpose of illustration, for A_{patch} (e.g., the bottom-right region of heat map 654), one pixel may represent one attention value. For A_{CLS}, since one pixel may be difficult to see due to size (e.g., for a single row and column of attention values), each attention value may be augmented to be multiple pixels (e.g., 10 pixels). The coloring and/or shading of heat map 654 may be consistent with token connection chart 653. From heat map 654, a diagonal-line pattern may be observed in the A_{patch} (e.g., patches→patches) region, which may indicate the patch tokens attend strongly to themselves. Additionally, the CLS token may strongly attend to itself (e.g., the top-left cell may be in darkly colored and/or shaded). Also, the CLS token may attend to different patch tokens, but the attention magnitude may be small (e.g., light color and/or shading in the top row). In some non-limiting embodiments or aspects, the threshold specified from histogram 657 may also apply to heat map 654.

In some non-limiting embodiments or aspects, by presenting the attention matrix in two different manners (e.g., token connection chart 653 and heat map 654), different attention patterns may be identified based on the two different visualizations that complement each other (e.g., one may be more intuitive for showing certain patterns than others). Also, for both token connection chart 653 and heat map 654, toggle 658 may switch between the raw attention and the roll-out attention visualizations.

Referring again to FIG. 9, and with continued reference to FIGS. 6A and 6D, to intuitively present the patch token related attention, the patches may be mapped back onto the images. For CLS→patches (e.g., with shape 1×p²) and patches→CLS (e.g., with shape p²×1) attentions, these may be reshaped to p×p squares; the squares may be scaled to w×w, and the scaled squares may be overlaid on top of the image as a mask to present the CLS attentions originating from or paid to different patches (e.g., as shown at 906 of FIG. 9). For the patches→patches attentions (e.g., with shape p²×p²), individual rows/columns may be reshaped into p×p squares, which may be scaled to w×w, and the scaled squares may be overlaid on top of the image as masks to show the attention from a token to all other tokens (e.g., a row) or vice versa (e.g., a column) (e.g., as shown at 907 in FIG. 9).

For the purpose of illustration, images 652 in head attention pattern view 604 may include original image 652-1, image+source attention mask 652-2, and image+target attention mask 652-3. In some non-limiting embodiments or aspects, hovering over individual source/target patches from the top/bottom list in token connection chart 653 or the row/column in heat map 654 may dynamically update the source/target attention mask of one or more of images 652.

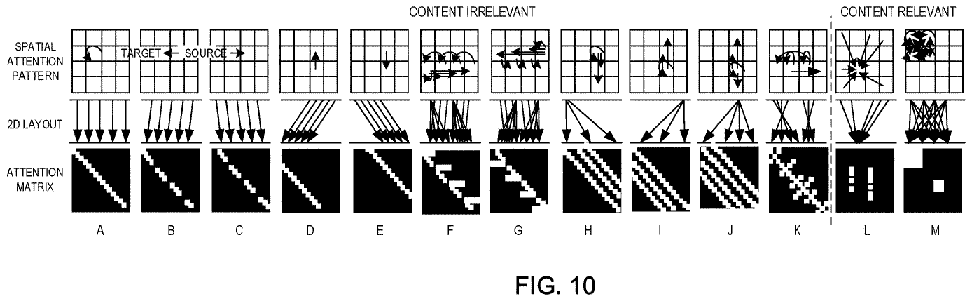

FIG. 10 is a diagram of attention patterns, according to some non-limiting embodiments or aspects. Each attention pattern A-M is shown spatially (e.g., spatial attention pattern at the top), linearly (e.g., 2D layout in the center), and as a matrix (e.g., attention matrix at bottom). In the spatial attention patterns, the arrows originate from the attention source patch (e.g., from layer l) and point at the attention target patch (e.g., from layer l−1). In the 2D layout, the top and bottom rows are from layer l and layer l−1, respectively, and the lines between show attentions. In the attention matrix, most patterns are hybrid patterns (e.g., combinations of four basic patterns: diagonal, horizontal, vertical, and block). For example, F is the combination of diagonal and horizontal patterns.

In some non-limiting embodiments or aspects, the diagonal and horizontal patterns (e.g., A to K) may attend to fixed neighboring patches and/or may be content irrelevant. Additionally or alternatively, the vertical and block patterns (e.g., L and M) may be relevant to the image content.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
receiving, with at least one processor, a trained transformer model, the trained transformer model comprising at least one multi-head self-attention layer comprising a plurality of attention heads;
receiving, with at least one processor, at least one sample;
inputting, with at least one processor, the at least one sample to the trained transformer model to generate at least one layer output of the at least one multi-head self-attention layer and at least one model output of the trained transformer model;
for each respective attention head of the plurality of attention heads, pruning, with at least one processor, the respective attention head and inputting the at least one sample to the trained transformer model with the respective attention head pruned to generate at least one respective pruned layer output of the at least one multi-head self-attention layer and at least one respective pruned model output of the trained transformer model; and
determining, with at least one processor, at least one importance metric for each respective attention head of the plurality of attention heads based on at least two of: the at least one layer output, the at least one model output, the at least one respective pruned layer output for the respective attention head, the at least one respective pruned model output for the respective attention head, or any combination thereof.

2. The method of claim 1, wherein the trained transformer model comprises a trained vison transformer (ViT) model and the at least one sample comprises at least one image.

3. The method of claim 1, wherein the at least one sample comprises a natural language sample.

4. The method of claim 1, wherein the at least one sample comprises at least one time series data item.

5. The method of claim 1, wherein pruning the respective attention head comprises setting at least a portion of a respective attention matrix of the respective attention head to 0.

6. The method of claim 1, wherein determining the at least one importance metric comprises determining at least one of:
a probability change importance metric based on the at least one model output and the at least one respective pruned model output for the respective attention head;
a Jensen-Shannon Divergence (JSD) importance metric based on the at least one model output and the at least one respective pruned model output for the respective attention head;
a layer importance metric based on the at least one layer output and the at least one respective pruned layer output for the respective attention head; or
any combination thereof.

7. The method of claim 6, wherein the layer importance metric comprises at least one of: a class token-based layer importance metric, a patch token-based layer importance metric, or any combination thereof.

8. The method of claim 1, further comprising:
for each respective attention head of the plurality of attention heads, generating, with at least one processor, a respective attention strength vector for the respective attention head based on an attention strength between each patch of the at least one sample and each other patch of the at least one sample.

9. The method of claim 1, wherein each respective attention head of the plurality of attention heads is associated with a respective attention matrix, wherein a plurality of attention matrices comprises the respective attention matrix for each respective attention head of the plurality of attention heads, the method further comprising:
generating, with at least one processor, a respective embedding for each respective attention matrix of the plurality of attention matrices, wherein a plurality of embeddings comprises each respective embedding for each respective attention matrix of the plurality of attention matrices;
clustering, with at least one processor, the plurality of embeddings to provide at least one cluster; and
determining, with at least one processor, at least one attention pattern based on the at least one cluster.

10. The method of claim 9, wherein generating the respective embedding for each respective attention matrix of the plurality of attention matrices comprises:
training, with at least one processor, an autoencoder based on the plurality of attention matrices to provide a trained autoencoder; and
generating, with at least one processor, a respective latent representation for each respective attention matrix of the plurality of attention matrices based on the trained autoencoder.

11. The method of claim 10, wherein the respective latent representation for each respective attention matrix comprises the respective embedding for each respective attention matrix.

12. The method of claim 10, wherein generating the respective embedding for each respective attention matrix of the plurality of attention matrices further comprises:
generating, with at least one processor, the respective embedding for each respective attention matrix of the plurality of attention matrices based on applying t-distributed stochastic neighbor embedding (tSNE) for each latent representation of each respective attention matrix of the plurality of attention matrices.

13. The method of claim 1, further comprising:
generating, with at least one processor, a graphical user interface comprising at least one view.

14. The method of claim 13, wherein the at least one view comprises at least one of:
a head importance view;
a head attention strength view;
a head attention pattern view;
an image overview view; or
any combination thereof.

15. A system comprising:
at least one processor; and
at least one non-transitory computer-readable medium storing instructions that, when executed by the at least one processor, cause the at least one processor to:
receive a trained transformer model, the trained transformer model comprising at least one multi-head self-attention layer comprising a plurality of attention heads;
receive at least one sample;
input the at least one sample to the trained transformer model to generate at least one layer output of the at least one multi-head self-attention layer and at least one model output of the trained transformer model;
for each respective attention head of the plurality of attention heads, prune the respective attention head and input the at least one sample to the trained transformer model with the respective attention head pruned to generate at least one respective pruned layer output of the at least one multi-head self-attention layer and at least one respective pruned model output of the trained transformer model; and
determine at least one importance metric for each respective attention head of the plurality of attention heads based on at least two of: the at least one layer output, the at least one model output, the at least one respective pruned layer output for the respective attention head, the at least one respective pruned model output for the respective attention head, or any combination thereof.

16. The system of claim 15, wherein pruning the respective attention head comprises setting at least a portion of a respective attention matrix of the respective attention head to 0.

17. The system of claim 15, wherein the instructions, when executed by the at least one processor, further cause the at least one processor to:
for each respective attention head of the plurality of attention heads, generate a respective attention strength vector for the respective attention head based on an attention strength between each patch of the at least one sample and each other patch of the at least one sample.

18. The system of claim 15, wherein each respective attention head of the plurality of attention heads is associated with a respective attention matrix, wherein a plurality of attention matrices comprises the respective attention matrix for each respective attention head of the plurality of attention heads, wherein the instructions, when executed by the at least one processor, further cause the at least one processor to:
generate a respective embedding for each respective attention matrix of the plurality of attention matrices, wherein a plurality of embeddings comprises each respective embedding for each respective attention matrix of the plurality of attention matrices;
cluster the plurality of embeddings to provide at least one cluster; and
determine at least one attention pattern based on the at least one cluster,
wherein generating the respective embedding for each respective attention matrix of the plurality of attention matrices comprises:
training an autoencoder based on the plurality of attention matrices to provide a trained autoencoder; and
generating a respective latent representation for each respective attention matrix of the plurality of attention matrices based on the trained autoencoder.

19. The system of claim 18, wherein generating the respective embedding for each respective attention matrix of the plurality of attention matrices further comprises:
generating the respective embedding for each respective attention matrix of the plurality of attention matrices based on applying t-distributed stochastic neighbor embedding (tSNE) for each latent representation of each respective attention matrix of the plurality of attention matrices.

20. A computer program product comprising at least one non-transitory computer-readable medium including program instructions that, when executed by at least one processor, cause the at least one processor to:
receive a trained transformer model, the trained transformer model comprising at least one multi-head self-attention layer comprising a plurality of attention heads;
receive at least one sample;
input the at least one sample to the trained transformer model to generate at least one layer output of the at least one multi-head self-attention layer and at least one model output of the trained transformer model;
for each respective attention head of the plurality of attention heads, prune the respective attention head and input the at least one sample to the trained transformer model with the respective attention head pruned to generate at least one respective pruned layer output of the at least one multi-head self-attention layer and at least one respective pruned model output of the trained transformer model; and
determine at least one importance metric for each respective attention head of the plurality of attention heads based on at least two of: the at least one layer output, the at least one model output, the at least one respective pruned layer output for the respective attention head, the at least one respective pruned model output for the respective attention head, or any combination thereof.
